(19) United States
(12) Patent Application Publication
(10) Pub. No.: US 2004/0198082 A1
(43) Pub. Date: Oct. 7, 2004

(54) Method of making an electrical connector

(76) Inventors: Victor Zaderej, St. Charles, IL (US); Arindum Dutta, Warrenville, IL (US); John E. Lopata, Naperville, IL (US)

Correspondence Address: MOLEX INCORPORATED, 2222 WELLINGTON COURT, LISLE, IL, 60532, US

(21) Appl. No.: 10/408,492

(22) Filed: Apr. 7, 2003

(51) Int. Cl. H01R 12/00

(52) U.S. Cl. 439/83

(57) ABSTRACT

A method of forming an electrical connector is provided. A mask having recesses is provided and solder is dispensed into the recesses. Contact tails from terminals in a connector are positioned below the mask and aligned with the recesses of the mask such that the contact tails either abut against the solder or are in close proximity thereto. As the solder is heated, it melts and flows onto the contact tails and forms masses of solder on the contact tails. The masses of solder are then allowed to cool and harden on the contact tails and the mask is removed. An electrical connector with the masses of solder connected thereto is thus provided.

### FIELD OF THE INVENTION

The present invention relates to a method of making an electrical connector.

### BACKGROUND OF THE INVENTION

There are many types of electrical connectors and methods of making same which are known in the prior art. One example of a method of making an electrical connector can be found in U.S. Pat. No. 6,421,912, which discloses filling a recess provided in the upper face of a mold member with a solder material, putting the front ends of connection sections of contact elements, which are housed in a housing, into the solder material, solidifying the solder material, and removing the connection sections from the mold member. Another example of a method of making an electrical connector can be found in U.S. Pat. No. 6,454,157, which discloses forming a well in a mounting surface of an electrical element, inserting a tail end of an elongated conductor into a portion of the electrical element such that the tail end of the elongated conductor occupies a portion of the well and terminates within a predefined range of the mounting surface, filling the well with a predefined amount of solder paste, placing a conductive body with the solder paste, and melting the solder paste such that the conductive body fuses to the conductor end.

### OBJECTS AND SUMMARY OF THE INVENTION

A primary object of the invention is to provide a method of making an electrical connector.

Another object of the invention is to form an electrical connector having a solder volume joined to a contact tail of terminals where the volume/diameter of the solder can be varied based on printed circuit board design requirements.

Yet another object of the invention is to provide a mask and housing used in forming the electrical connectors which are simple to customize based on the system design requirements;

Still another object of the invention is to form an electrical connector by a method which eliminates the need to purchase solder volume in the shape of spheres.

Another object of the invention is to utilize a mask in the formation of the electrical connector which can be reused.

Another object of the invention is to form an electrical connector using parts which are easily aligned with one another for the formation of the electrical connector.

Briefly, and in accordance with the foregoing, the invention provides a method of forming an electrical connector. A first embodiment of the method includes providing a mask having recesses formed at a first surface thereof. Solder is dispensed into the recesses of the mask. Contact tails from terminals in a connector are then positioned above the mask and aligned with the recesses of the mask such that the contact tails either touch the solder or are in close proximity thereto. The mask and the connector are then flipped over and sent through a reflow oven. As the solder is heated, it melts and flows onto the contact tails of the terminals and forms masses of solder on the contact tails. The masses of solder are then allowed to cool and harden on the contact tails. The mask is removed. An electrical connector with the masses of solder connected thereto is thus provided. A second embodiment of the method includes providing a mask having recesses formed in a second surface thereof and passageways which extend from a first surface of the mask to the respective recess. Solder is dispensed through the passageways and into the recesses of the mask. Contact tails from terminals in a connector are then positioned below the mask and aligned with the recesses of the mask such that the contact tails either touch the solder or are in close proximity thereto. The mask and the connector are then sent through a reflow oven. As the solder is heated, it melts and flows onto the contact tails of the terminals and forms masses of solder on the contact tails. The masses of solder are then allowed to cool and harden on the contact tails. The mask is removed. An electrical connector with the masses of solder connected thereto is thus provided.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a connector utilized in the method of the present invention;

FIG. 2 is a side-elevational view of the connector shown in FIG. 1;

FIG. 2a is a cross-sectional side-elevational view of an alternative embodiment of the connector used in the method of the present invention;

FIG. 3 is a perspective view of a mask utilized in the method of the present invention;

FIG. 4 is a partial cross-sectional side-elevational view of the mask shown in FIG. 3, taken along line 4-4;

FIG. 5 is a perspective view of a member utilized in the method of the present invention;

FIGS. 6-13 illustrate the method of performing the present invention, wherein FIGS. 6-7 and 10-13 are cross-sectional side-elevational views and wherein FIGS. 8 and 9 are perspective views;

FIG. 14 illustrates the connector formed by the method of the present invention being connected to a printed circuit board;

FIGS. 15a-15d illustrate an alternative method of performing the present invention with a second alternative embodiment of the mask utilized in the present invention and shown in FIGS. 3-4;

FIG. 16 illustrates a cross-sectional view of a second alternative embodiment of the mask utilized in the present invention and shown in FIGS. 3-4;

FIG. 17 illustrates a cross-sectional view of the mask having solder selectively dispensed in only a portion of the recesses of the mask;

FIGS. 18a-18g are perspective views of different types of contact tails for the terminal; and

FIG. 19 is a perspective view of an alternative embodiment of the mask, connector and member utilized in performing the method of the present invention.

### DETAILED DESCRIPTION OF THE ILLUSTRATED EMBODIMENT

While this invention may be susceptible to embodiment in different forms, there is shown in the drawings and will be described herein in detail, specific embodiments with the understanding that the present disclosure is to be considered an exemplification of the principles of the invention, and is not intended to limit the invention to that as illustrated.

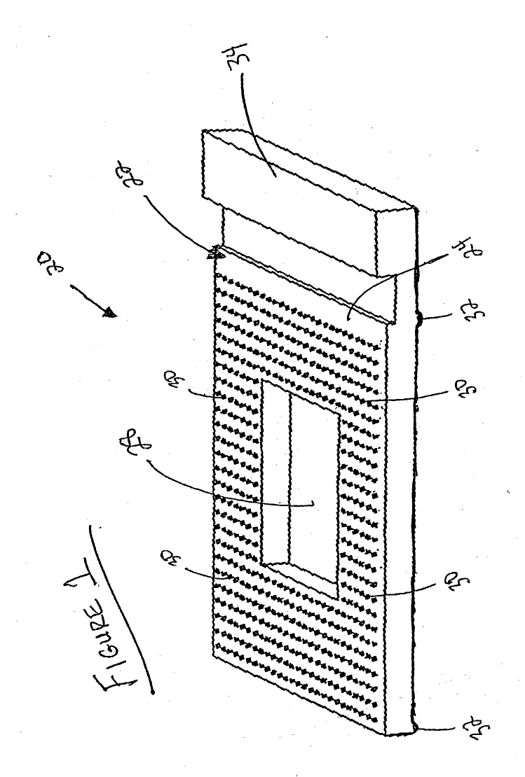

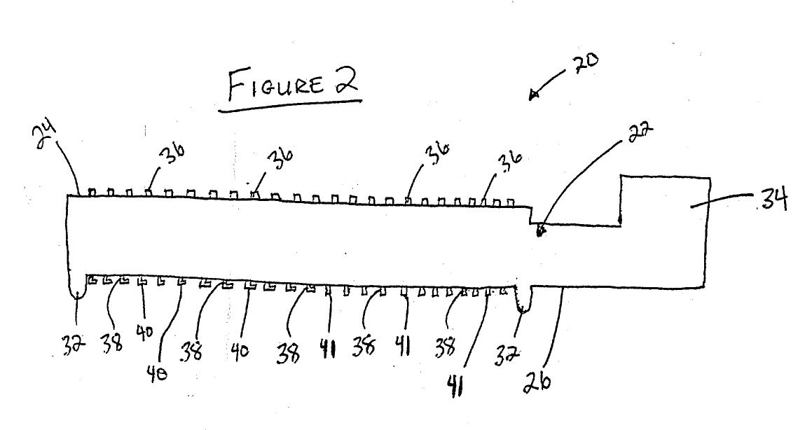

A connector 20 which is used in the method of the present invention is illustrated in FIGS. 1 and 2. The connector 20 includes a housing 22 having a first surface 24 and a second surface 26. In the preferred embodiment, the housing 22 has a generally rectangular aperture 28 which extends through the housing 22 from the first surface 24 to the second surface 26. Surrounding the aperture 28, the housing 22 has a plurality of apertures 30 which extend through the housing 22 from the first surface 24 to the second surface 26. The aperture 28 is much larger than each of the apertures 30. As illustrated in FIGS. 1 and 2 the second surface 26 preferably has protrusions 32 extending downwardly therefrom away from the top and second surfaces 24, 26. The housing 22 also has an end portion 34 which does not have any apertures extending therethrough. The end portion 34 of the housing 22 is thicker than the remainder of the housing 22 such that the first surface 24 of the housing 22 is further from the second surface 26 of the housing 22 at the end portion 34 than at the remainder of the housing 22.

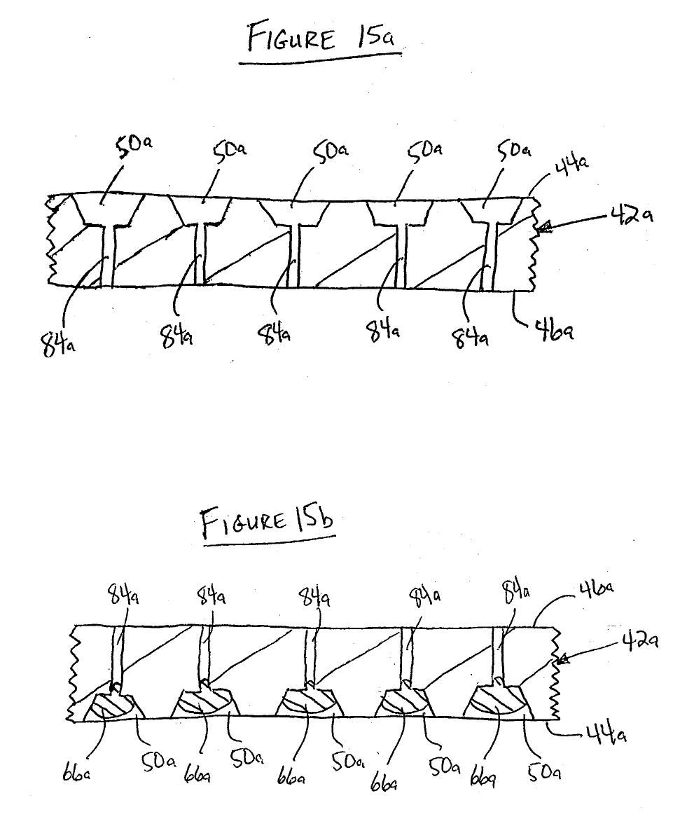

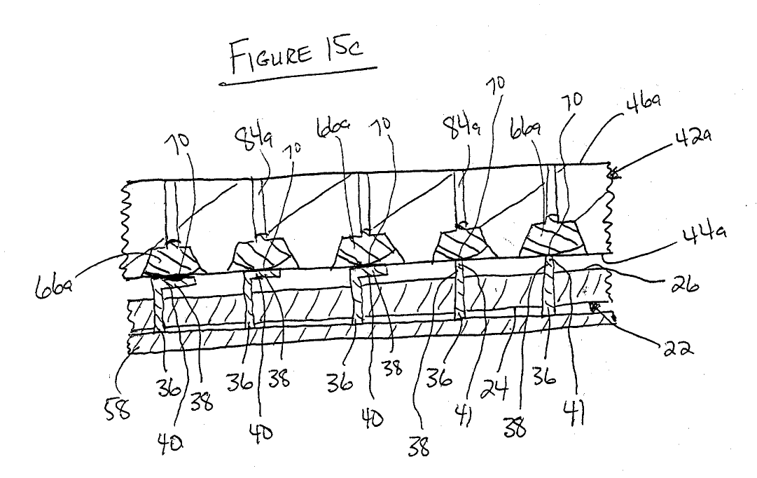

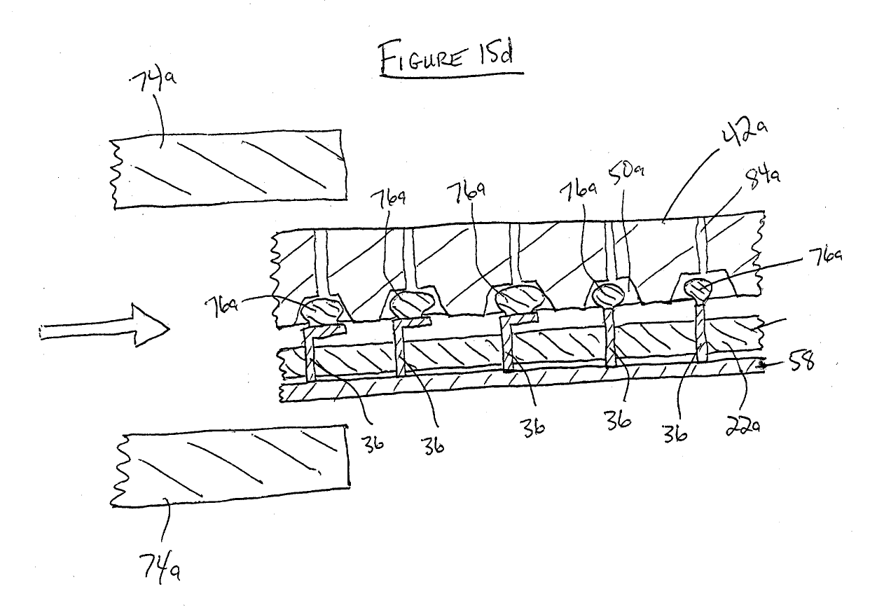

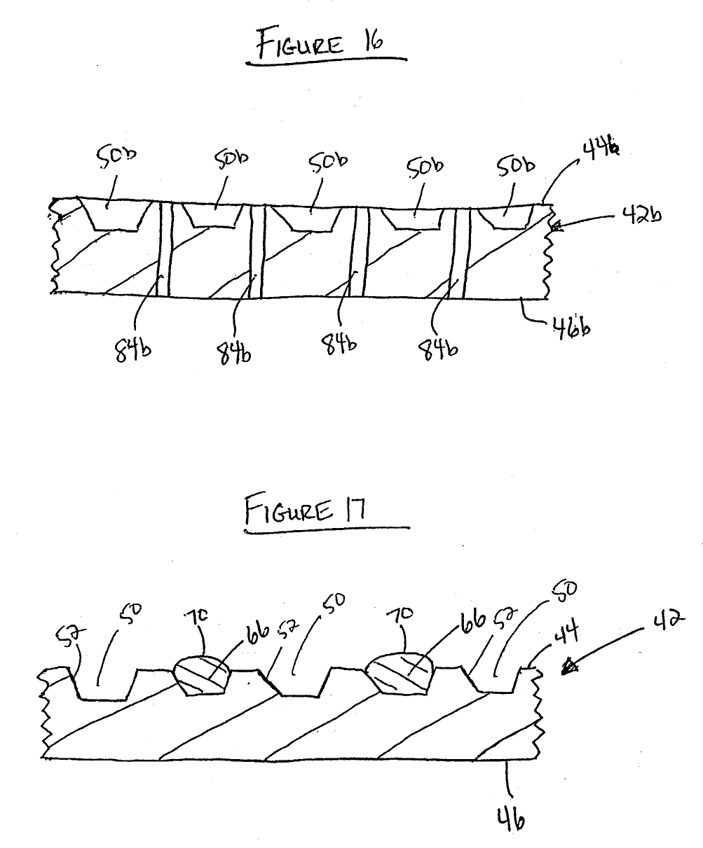

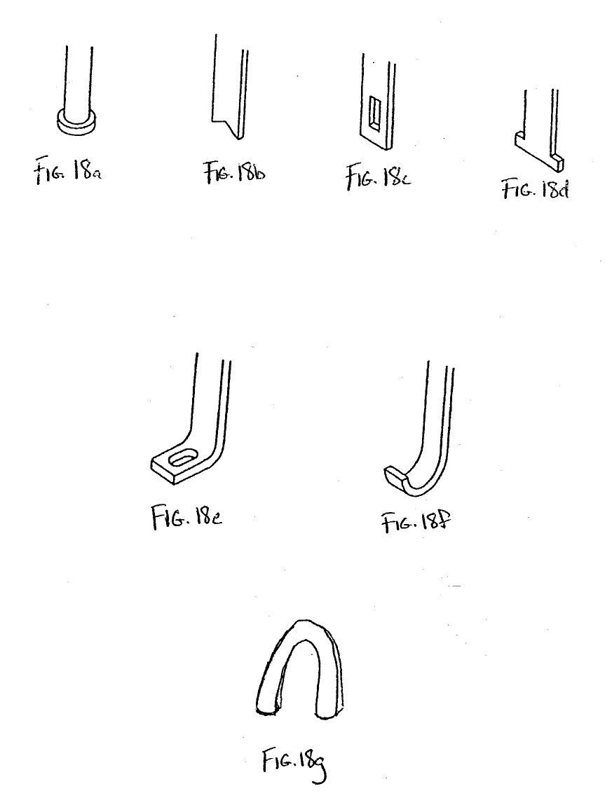

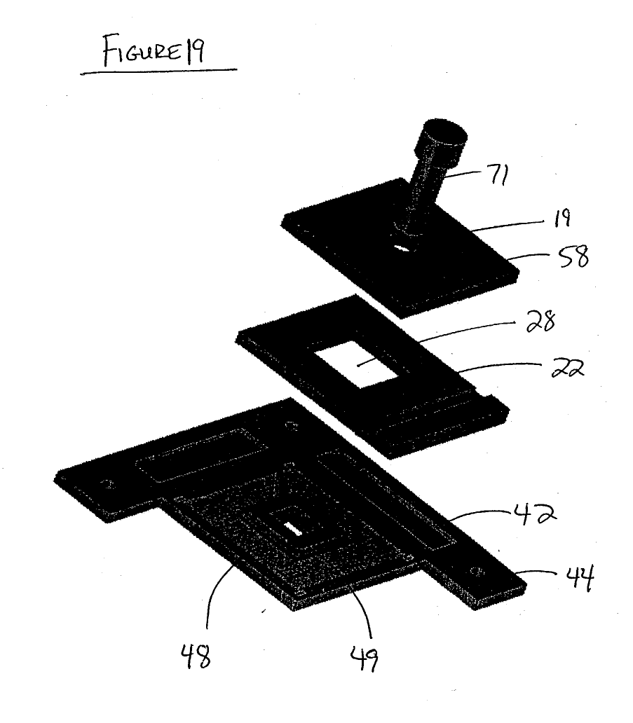

A terminal 36 is positioned and connected within each of the apertures 30 such that a contact tail 38 of each terminal 36 projects from the second surface 26 of the housing 22. Alternatively, as illustrated in FIG. 2a, the contact tails 38 of each terminal 38 could be provided in recesses 37 of the housing 22 such that the contact tails 38 do not project beyond the second surface 26 of the housing 22. The contact tail 38 of each terminal 36 may be L-shaped or straight, as illustrated in FIG. 2, or shaped like the terminals illustrated in FIGS. 18a-18g. It should be noted that while FIGS. 2, 7, and 10-14 illustrate contact tails 38 being either L-shaped or straight, it is preferably that the contact tails 38 either all be L-shaped or all be straight. FIG. 18g specifically illustrates a terminal which is formed of wire and which is U-shaped such that it has a pair of straight contact tails. If L-shaped, a short leg 40 of the contact tail 38 is parallel to the second surface 26 of the housing 22. If straight, an end 41 of the contact tail 38 is parallel to the second surface 26 of the housing 22. Each terminal 36 is preferably plated, and is preferably selectively plated with either gold or nickel, with gold being preferably over nickel; each terminal 36 is preferably not overall plated with tin or tin lead alloy, for reasons described herein.

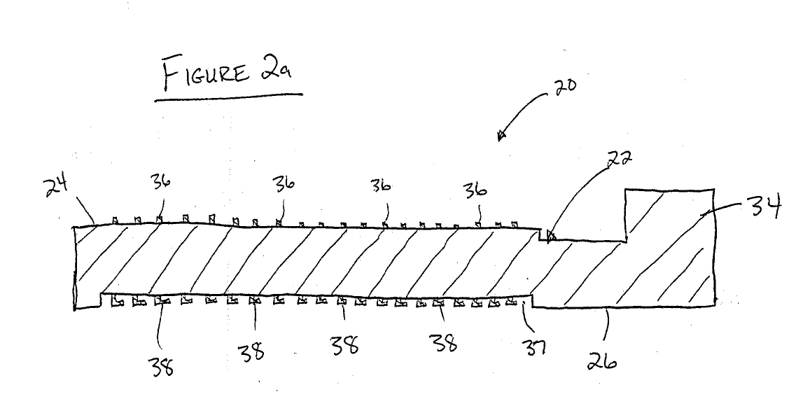

A substrate or mask 42 is illustrated in FIGS. 3 and 4. The mask 42 has a first surface 44 and a second surface 46. In the preferred embodiment, the mask 42 has a generally rectangular aperture 48 which extends through the mask 42 from the first surface 44 to the second surface 46. The aperture 48 is preferably identical in size and shape as the aperture 28 which extends through the housing 22, for reasons discussed further herein. Alternatively, as illustrated in FIG. 19, the mask 42 may have a protrusion or raised portion 49 extending upwardly from the first surface 44 thereof. The protrusion 49 is sized to fit within the aperture 28 of the housing 22 to assist in the alignment of the housing 22 and the mask 42 for reasons discussed further herein. The protrusion 49 provides the aperture 48 therethrough, although the aperture 48 is not identical in size to the aperture 28 which extends through the housing 22.

The mask 42 has a plurality of recesses 50 provided therein at the first surface 44 thereof. Each recess 50 has a conical sidewall 52, such that the sidewall 52 tapers inwardly, as best illustrated in FIG. 4. The recesses 50 are configured such that the contact tails 38 of each terminal 36 can be positioned in alignment with, or slightly off-center of, the recesses 50 when the housing 22 and the mask 42 are brought together, as will be described in further detail herein.

The mask 42 may have indents 54 provided in the first surface 44 which are configured such that the protrusions 32 on the housing 22 are positioned partially within the indents 54 when the housing 22 and the mask 42 are brought together. It should be understood that the number and positioning of the protrusions 32 on the housing 22 and the indents 54 on the mask 42 can be varied as desired. Alternatively, the protrusions 32 and the indents 54 can be eliminated from the assembly and an outside object used to space the housing 22 and the mask 42 apart the desired distance.

The mask 42 may have three generally circular apertures 56 extending therethrough which can be configured for retaining a plurality of different types of fasteners therein.

The mask 42 is preferably formed of a high temperature material, such as thermoplastic LCP which is capable of withstanding subsequent processing. Metal is not preferred because of wetting in the recesses 50, but can be used if surface treated to prevent wetting. The mask 42 is preferably formed by molding, but the mask 42 could also be formed by machining.

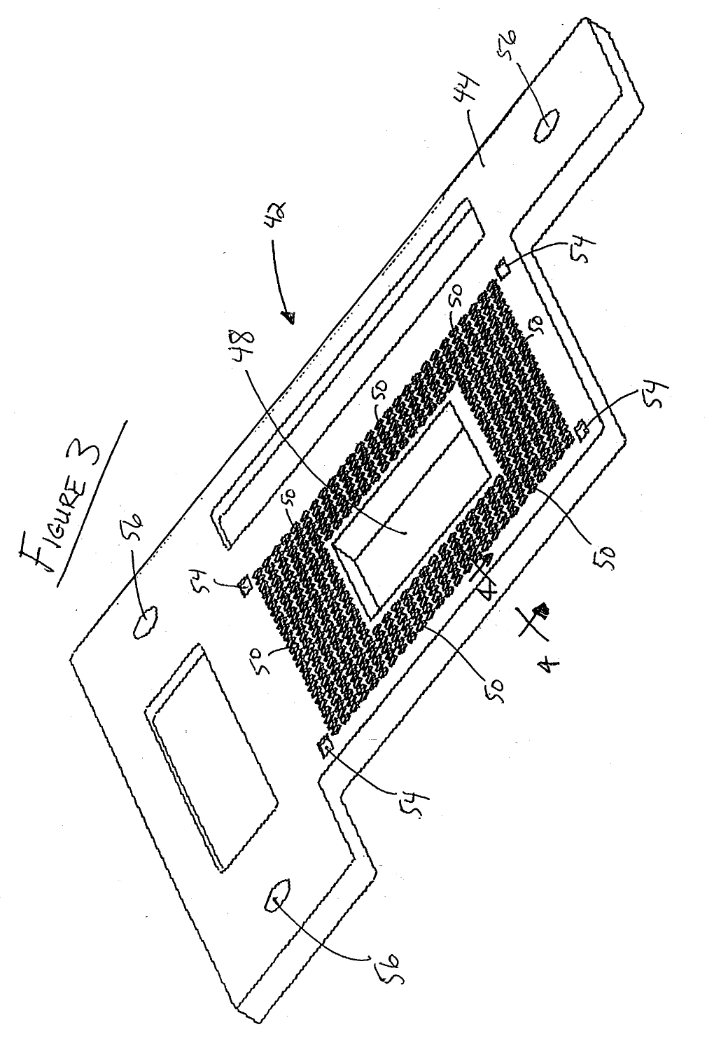

A heat shielding member 58 is illustrated in FIG. 5. The heat shielding member 58 has a first surface 60 and a second surface 62. The heat shielding member 58 preferably has three generally circular apertures 64 extending therethrough. The apertures 64 may be threaded if desired. The apertures 64 are configured to be in alignment with the apertures 56 of the mask 42 when the heat shielding member 58, the connector 20 and the mask 42 are brought together. The heat shielding member 58 may also have an aperture 65 therethrough, as illustrated in FIG. 19. In the embodiment of the heating shielding member 58 of FIG. 19 is used, the apertures 64 are eliminated.

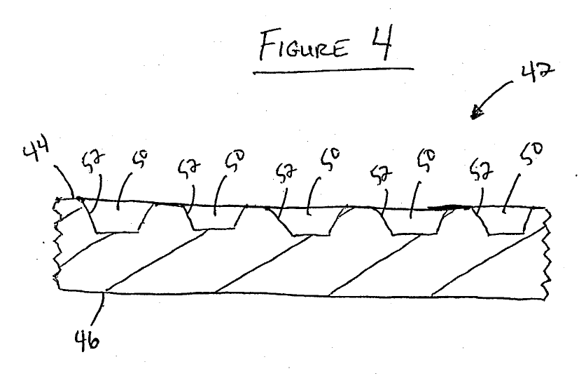

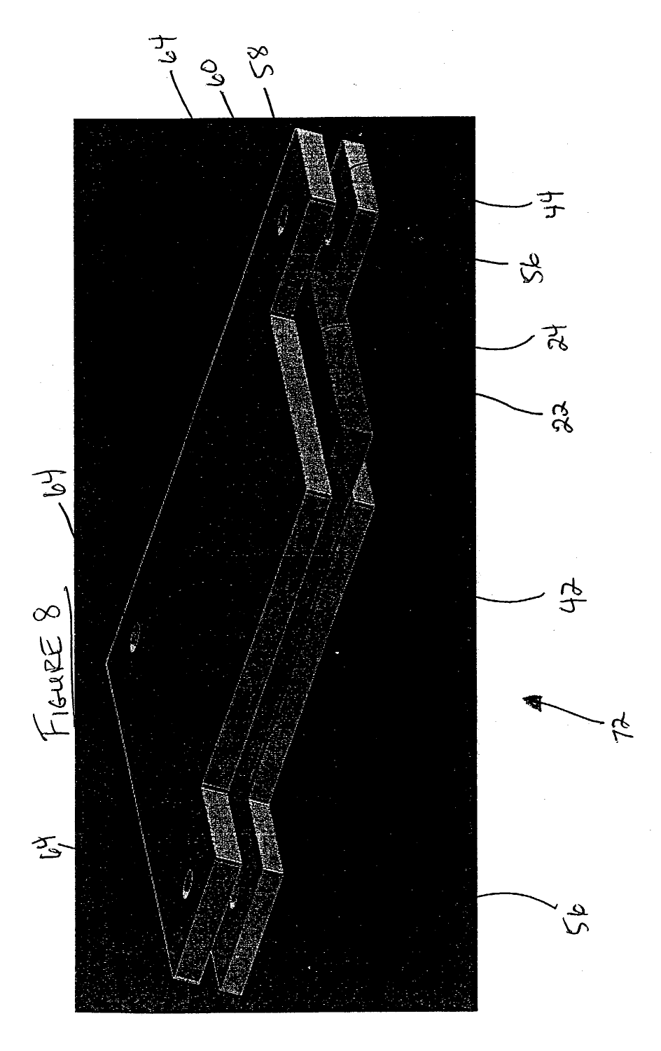

Attention is directed to FIGS. 6-13 which illustrate the method of attaching a fusible material, such as solder 66, to the connector 20 to form an electrical connector 68, illustrated in FIG. 13. The method begins by placing the solder 66 into each of the recesses 50 of the mask 42 as illustrated in FIG. 6. The solder 66 is typically in the form of a paste. Either the solder 66 contains flux or the terminals 36 have flux applied thereto for assisting in the fusion of the solder 66 to the terminals 36. The solder 66 can be placed into the recesses 50 either by screen printing, i.e., using the mask 42 as a stencil and then squeegeeing, or by dispensing the solder 66 into the recesses 50. Both of these are conventional methods and are well known in the art such that they will not be further described herein. A meniscus 70 of the solder 66 is typically formed which extends beyond the first surface 44 of the mask 42. If desired, any solder 66 which extends beyond the first surface 44 of the mask 42 during the screen printing can be removed. If the solder 66 is dispensed into the recesses 50, the volume of the solder 66 can be controlled such that the solder 66 does not extend beyond the first surface 44 of the mask 42.

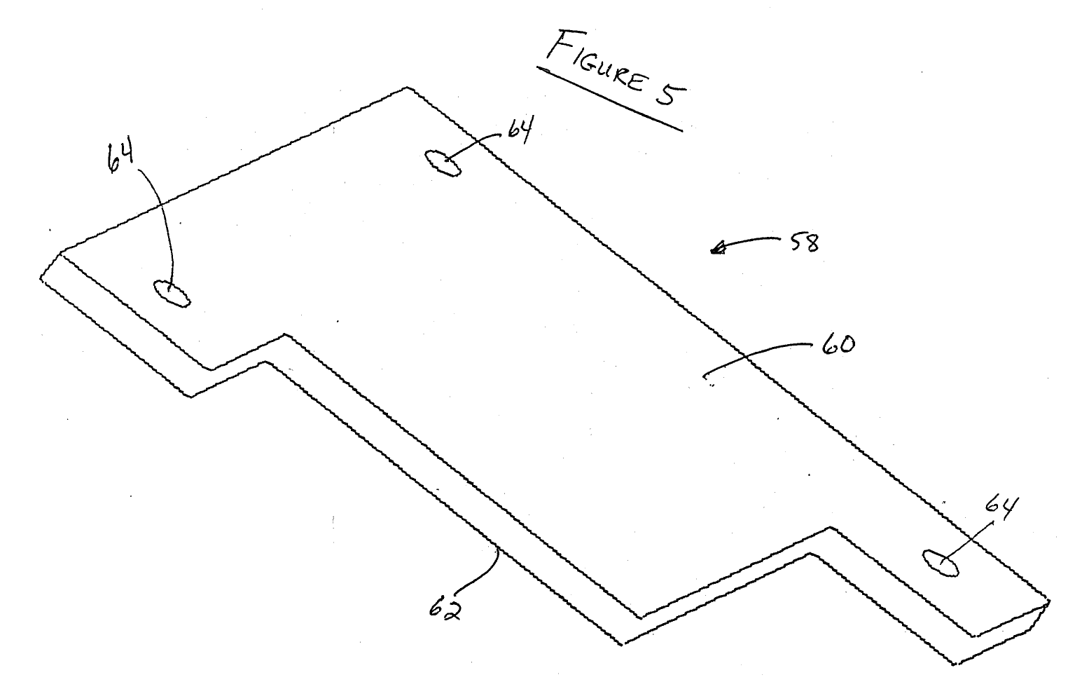

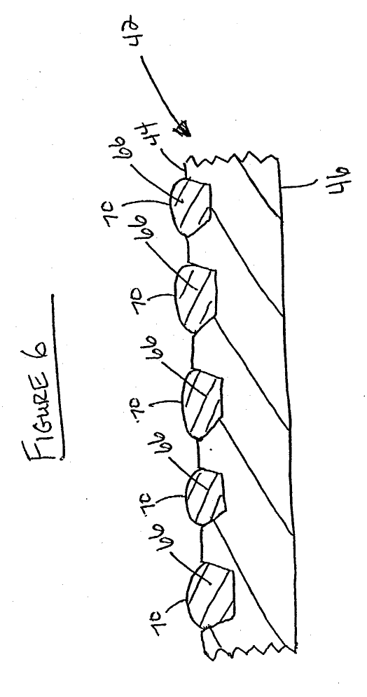

Once the solder 66 is positioned within the recesses 50 of the mask 42, the housing 22 and the mask 42 are brought together such that the second surface 26 of the housing 22 faces the first surface 44 of the mask 42. The apertures 28, 48 are preferably aligned and the protrusions 32 on the housing 22 are positioned within the indents 54 of the mask 42, such that the contact tail 38 of each terminal 36 becomes aligned with one of the recesses 50 of the mask 42. It should be noted that the protrusions 32 on the housing 22 and the indents 54 of the mask 42 are not necessary for alignment or for the proper performance of the method of the invention. As illustrated in FIG. 7, the contact tails 38 of each terminal 36 extend toward the recesses 50 such that the short leg 40 of the L-shaped contact tails 38, or the end 41 of the straight contact tails 38, will either abut against meniscus 70 of the solder 66, as illustrated in FIG. 7, or will be in close proximity to, but not touching, the solder 66, as illustrated in FIG. 7a. In any event, if an L-shaped contact tail 38 is used, the short leg 40 does not extend into the solder 66; if a straight contact tail 38 is used, the end 41 does not extend into the solder 66. It should be noted that while the contact tails 38 of the terminals 36 are shown completely over the center of the solder 66 in FIGS. 7 and 7a, the contact tails 38 may be slightly offset from the center of the solder 66, as will be further explained herein. If desired, a block or peg 71 may be positioned within the apertures 28, 48, and, if applicable, 65, to further ensure proper alignment, as illustrated in FIGS. 9 and 19. A variety of alignment features other than those described herein could also be used.

As illustrated in FIGS. 8 and 9, once the housing 22 of the connector 22 is positioned on the mask 42, the mask 42 and the connector 20 are clamped together by an appropriate clamping mechanism. The clamping mechanism can be provided by the heat shielding member 58 being positioned on the housing 22 such that the second surface 62 of the heat shielding member 58 abuts against the first surface 24 of the housing 22. The apertures 64 of the heat shielding member 58 are positioned in alignment with the apertures 56 of the mask 42. The heat shielding member 58 and the mask 42 are connected together by fasteners (not shown), such as screws, which extend through both the apertures 64 of the member 58 and the apertures 56 of the mask 42. It should be noted that the alignment of the apertures 64 and 56 is not critical if the heat shielding member 58 is connected to the mask 42 by secondary fasteners other than screws, such as clamps or quick release probes, as the heat shielding member 58 has only two main functions, to hold the housing 22 to the mask 42, and to absorb heat. As the heat shielding member 58 and the mask 42 are connected together, the connector 20 is clamped between the heat shielding member 58 and the mask 42. The clamping force provided on the connector 20 by the heat shielding member 58 and the mask 42 is uniform on all of the terminals 36, the housing 22 is brought into uniform contact with the mask 42 such that there is no distortion clamping. The combination 72 of the heat shielding member 58, the mask 42 and the connector 20 is illustrated in FIGS. 8 and 9.

Alternative clamping mechanisms, such as a pair of platens (not shown) could also be used. The member 58 could be part of a separate clamping mechanism which clamps the mask 42 and the connector 20 together. If the separate clamping mechanism is utilized, the member 58 may not be required if the temperature gradient can be achieved without the member 58. In any event, whatever clamping mechanism is used, it is important that it applies a uniform load to the connector 20 and the mask 42.

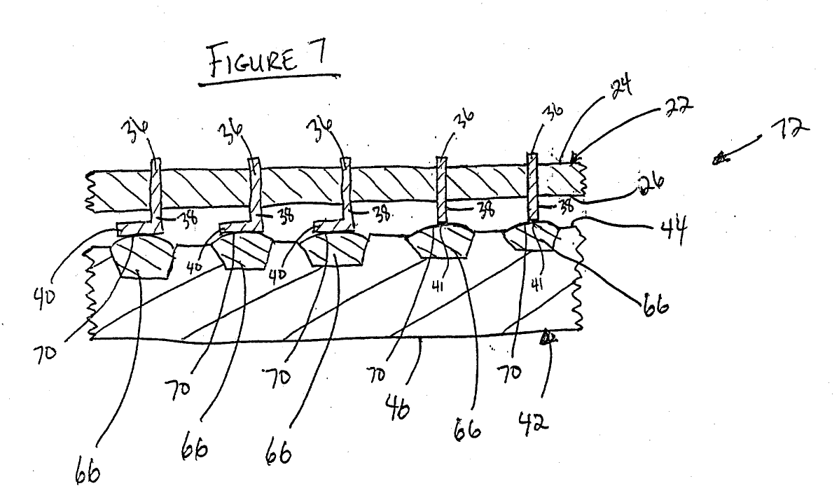

As illustrated in FIG. 10, the combination 72 is flipped over. Once the combination 72 is inverted, if the meniscus 70 of the solder 66 is in contact with the short leg 40 of the L-shaped contact tail 38, or with the end 41 of the straight contact tail 38, of the terminals 36 prior to the heating of the solder 66 within the oven 74, less reliance is placed on gravity for the flow of the solder 66 while more reliance is placed on the formation of uniform volumes of solder 76. Surface tension holds the solder 66 within the recesses 50.

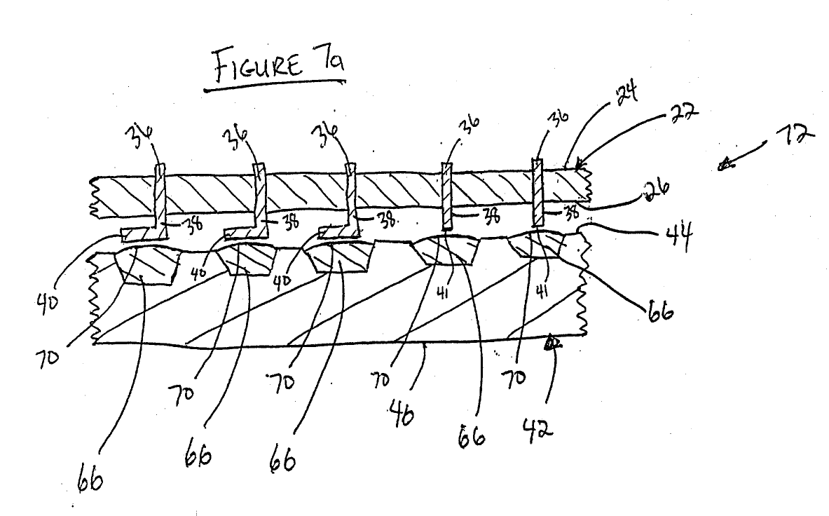

The combination 72 is sent through a reflow or convection oven 74 to heat the combination 72, as illustrated in FIG. 11. As the temperature is increased within the oven 74, the heat shielding member 58 maintains temperature differential because the controls of the oven 74 typically only provide limited temperature control, the solder 66 melts and flows down onto the short leg 40 of the L-shaped contact tail 38, or onto the end 41 of the straight contact tail 38, of each of the terminals 36. Because of surface tension, the melted solder 66 forms a volume of solder 76 which rests on the short leg 40 of the L-shaped contact tail 38, or on the end 41 of the straight contact tail 38.

The sidewall 52 of each recess 50 is preferably tapered to assist the solder 66 in flowing down onto the short leg 40 of the L-shaped contact tail 38, or onto the end 41 of the straight contact tail 38, of each of the terminals 36, when the solder 66 is not previously in contact with the contact tails 38, as illustrated in FIG. 7a. If 100% of the solder 66 is positioned within the recess 50, once the combination 72 is flipped over, it has been found that 30% of the solder 66 will flow onto the short leg 40 of the L-shaped contact tail 38, or onto the end 41 of the straight contact tail 38, because flux and packing density of each of the masses of solder 76. This is the typical volume reduction from initial due to volatilization of flux materials. The value may change because of the type of flux used.

As explained hereinabove, the terminals 36 should not be overall plated in tin or tin lead alloy. The terminals 36 are selectively plated with gold and/or nickel at various regions on the terminal that minimize or eliminate wetting and assure solder ball creation. This is because wicking can occur such that the solder 66 would flow down the terminal 36, rather than sitting on the short leg 40 of the L-shaped contact tail 38, or on the end 41 of the straight contact tail 39, of the terminals 36. Also, as explained hereinabove, metal cannot be used in the mask 42. This is because metal will cause wetting in the recesses 50, which would reduce the flow of the solder 66.

It should be noted that if a gap is provided between the terminal 36 and the housing 22, the solder 66 may try to flow down the terminal 36 and not sit on the short leg 40 of the L-shaped contact tail 38, or the end 41 of the straight contact tail 38, of the terminal 36. Should a gap be provided, use of a heat barrier or heat sink 77, illustrated in FIG. 11 provided at the first surface 24 of the housing 22 can be used to create a temperature differential of at least one (1) degree Celsius so that the mass of solder 76 would form on the short leg 40 of the L-shaped contact tail 38, or on the end 41 of the straight contact tail 38, of the terminals 36. The mass of solder 76 are preferably either formed as having domed surfaces, as illustrated in FIG. 11, or as semi-spheres, as illustrated in FIG. 11a.

It should also be noted that, in some instances, it may be advantageous to have some of the solder 66 flow down the terminal 36 toward the first surface 24 of the housing 22, while having some of the solder 66 form masses of solder 76 on the short leg 40 of the L-shaped contact tail 38, or on the end 41 of the straight contact tail 38, of the terminals 36, as illustrated in FIG. 12a.

After the masses of solder 76 are formed on either the short legs 40 of the L-shaped contact tails 38 or on the ends 41 of the straight contact tails 38, of each of the terminals 36, the combination 72 can be disassembled by releasing the clamping mechanism, such as the fasteners which attached the member 58 to the mask 42, removing the alignment fixtures, such as the block or peg 71 within the apertures 28, 48, 65 if the block or peg 71 was provided, and moving the mask 42 out of contact with the housing 22 of the connector 20 such that only the connector 20 with masses of solder 76 attached thereto remains, as illustrated in FIG. 12. The masses of solder 76 are positioned either on the short leg 40 of the L-shaped contact tail 38, or the end 41 of the straight contact tail 38, of each of the terminals 36. The masses of solder 76 are then allowed to cool and harden. It should be noted that the terminals 36 preferably do not extend into the masses of solder 76, but rather form a joint therebetween, such as a butt joint. However, it is noted that the terminals 36 may slightly extend into the masses of solder 76.

Once the masses of solder 76 are cooled and are joined to either the short leg 40 of the L-shaped contact tail 38, or to the end 41 of the straight contact tail 38, of each of the terminals 36, the connector 20 with masses of solder 76 attached is then flipped over again as illustrated in FIG. 13.

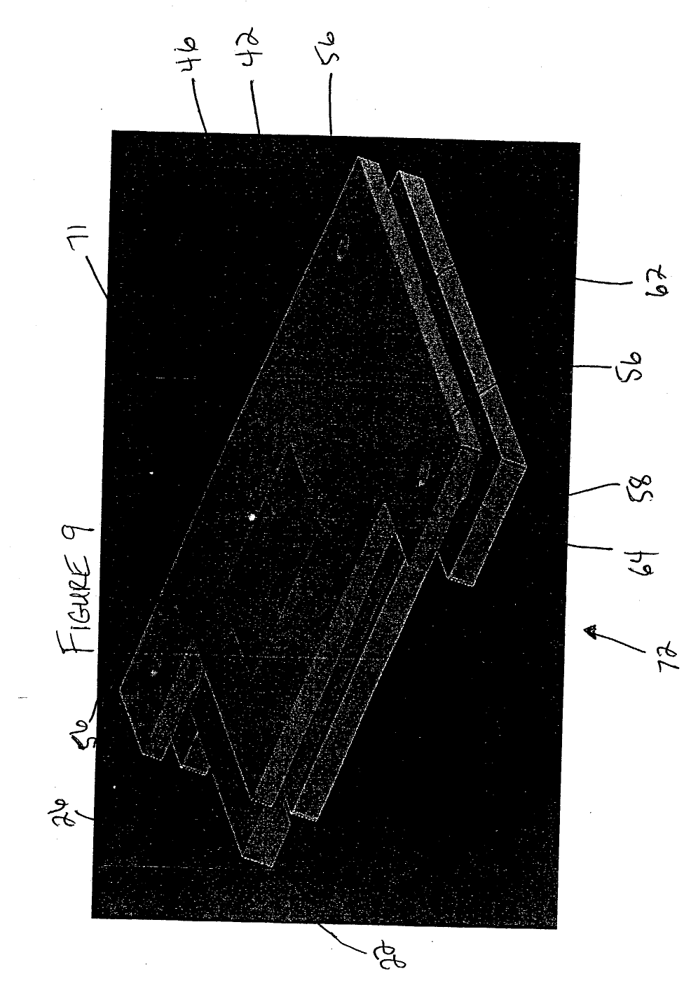

The connector 20 with masses of solder 76 can then be connected to a printed circuit board 78 in any suitable manner known in the art. As illustrated in FIG. 14, the printed circuit board 78 may have blind or buried vias 80 which would interconnect the terminals 36 to different printed circuit board layers 82a, 82b. Because of this, if desired, the masses of solder 76 can be formed to have different volumes/diameters in order to fill the blind vias 80 and interconnect to the internal printed circuit board layers 82a, 82b. The volume/diameter of the masses of solder 76 would be controlled by the unit (not shown) dispensing the solder 66 into the recesses 50 of the mask 42 and/or the size of the recesses 50. Typically, though, the masses of solder 76 would be of the same diameter/volume within a tolerance range. The masses of solder 76 are also coplanar and are controlled by the short legs 40 of the L-shaped contact tails 38, or the ends 41 of the straight contact tails 38, of the terminals 36.

If desired, the second surface 26 of the housing 22 could also be configured to have a stepped profile to control the location of the masses of solder 76 to maintain coplanarity requirements.

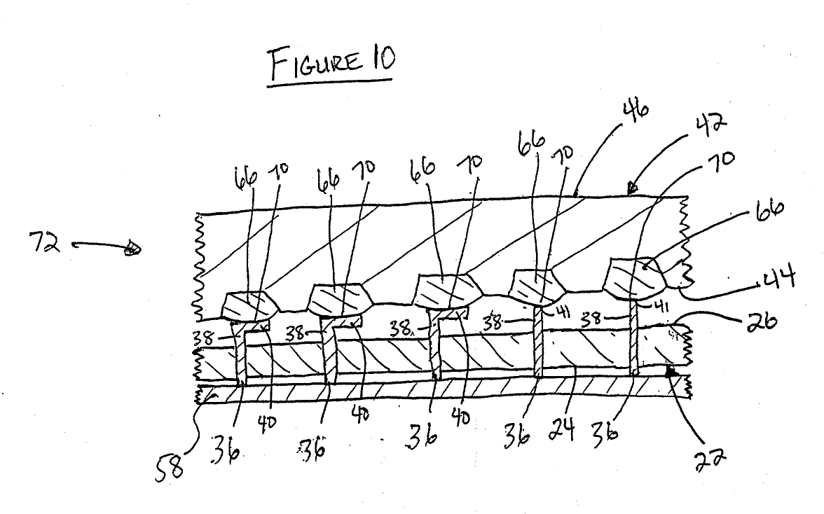

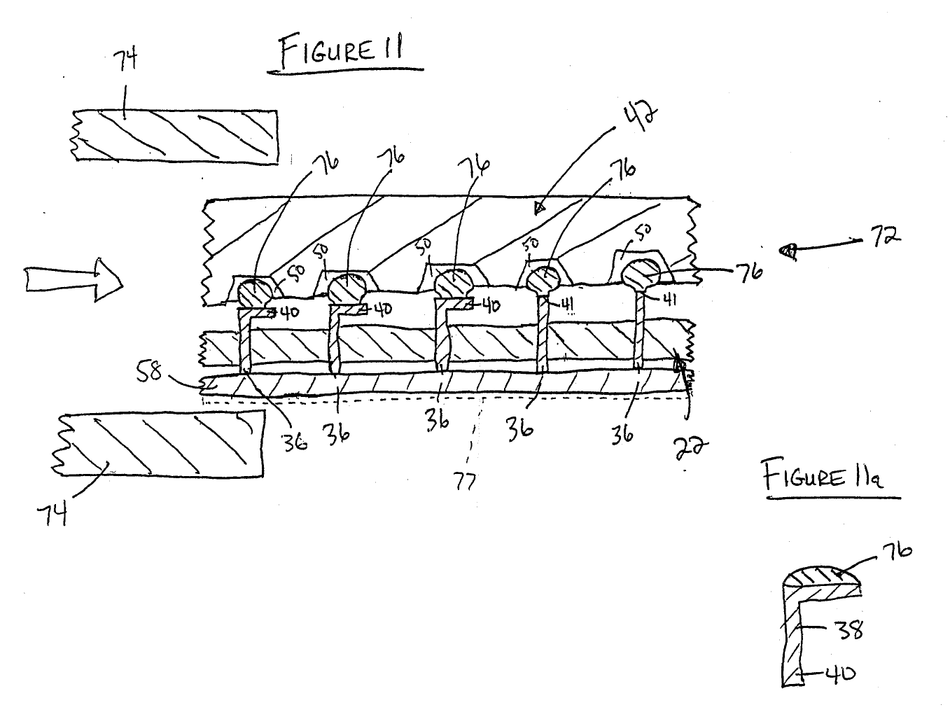

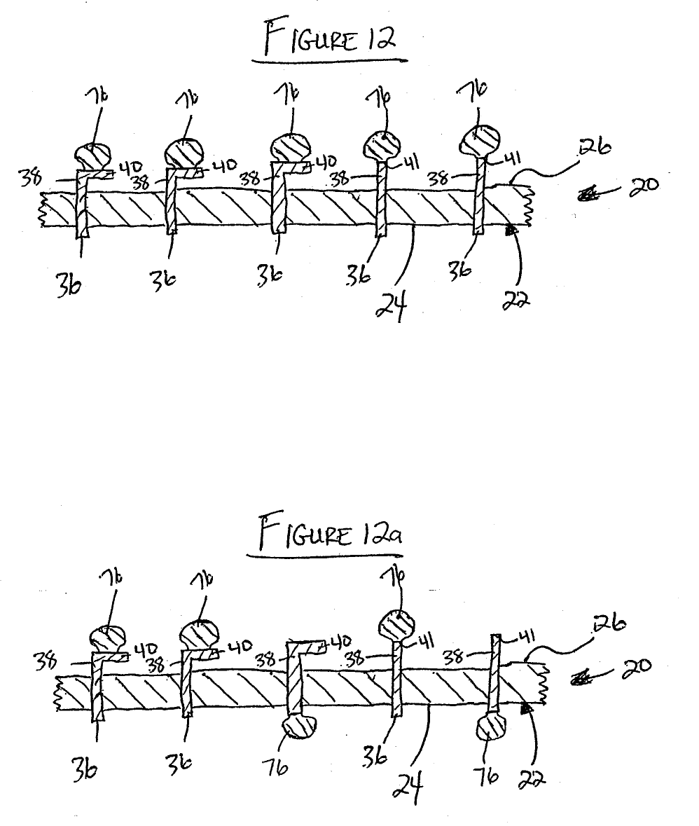

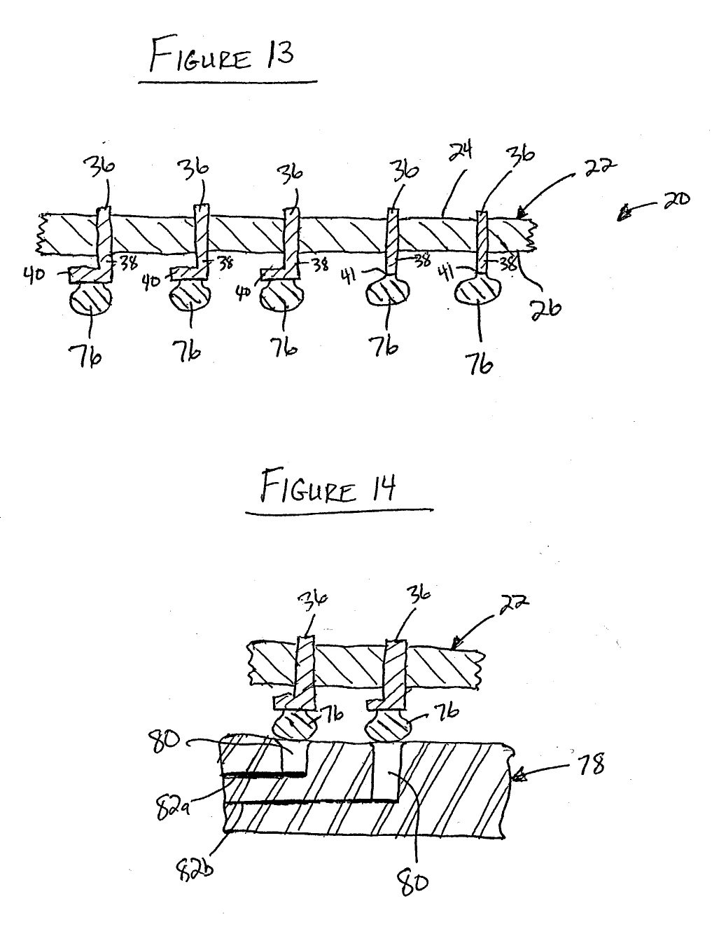

Alternate forms of the mask 42 could be formed which would allow flux to volatalize easier, to accelerate the reflow process. For instance, as illustrated in FIG. 15a, through passageways 84a can be provided in the mask 42a which extend from the second surface 46a of the mask 42a into the recess 50a. Also, as illustrated in FIG. 16, through passageways 84b can be provided through the mask 42b which extend from the second surface 46b of the mask 42b to the first surface 44b of the mask 42b, and which are positioned between the recesses 50b formed in the mask 42b.

The mask 42b is also utilized in a second embodiment of the method. The mask 42b is initially positioned above the housing 22b such that the terminals 36b are positioned below the recesses 50b, as illustrated in FIG. 15b. The solder 66b is dispensed from above the mask 42b into the passageways 84b of the mask 42b such that the solder 66b flows into the passageways 84b and the recesses 50b and adheres therein because of surface tension, as illustrated in FIG. 15c. The mask 42b and the housing 22b are sent through the reflow oven 74b to heat the solder 66b, as illustrated in FIG. 15d, such that the solder 66b melts and flows down onto the contact tail 38 of each of the terminals 36b. Because of surface tension, the melted solder 66b forms a mass of solder 76b which rests on the contact tail 38b of each terminal 36b, as illustrated in FIG. 15d. The remainder of the process when using the mask 42b is then identical to FIGS. 12-13, and the description thereof. Thus, using the mask 42b eliminates the need for flipping over the mask 42b and the housing 22b, which is required when using mask 42 or mask 42b. In each embodiment, however, the terminals are positioned beneath the mask when passed through the reflow oven.

The invention provides a number of advantages over the prior art: the volume of the solder 66 can be added based on the printed circuit board design requirements; all contact tails 38 of the terminals 36 can be configured to be either the same or different lengths; the profile of the housing 22 can be adjusted to create masses of solder 76 on the short legs 40 of the contact tails 38 of the terminals 36; it is easy to customize the mask 42 and the housing 22 to the system design requirements; different size masses of solder 76 can be created by varying the size of the recesses 50 in the mask 42; the capability of filling larger vias 80 can be achieved by using large volume/diameter masses of solder 76, volume differences for signal/power/ground circuitry; the need to buy masses of solder 76 is eliminated, two diameters difficult to process; the mask 42 is capable of being reused, even though it may have flux, as the mask 42 can be washed to remove flux; and solder 66 could be selectively dispensed into predefined recesses 50 such that some of the recesses 50 need not be filled if the configuration of the connector 20 does not demand it, as illustrated in FIG. 17.

While preferred embodiments of the invention are shown and described, it is envisioned that those skilled in the art may devise various modifications without departing from the spirit and scope of the foregoing description and the appended claims.

1. A method of making an electrical connector comprising the steps of:
a) providing a mask having a first surface, a second surface, and a plurality of recesses formed in said first surface;
b) providing a connector comprising a housing having a plurality of terminals provided therethrough, each said terminal having a contact tail proximate to a surface of said housing;
c) filling preselected said recesses of said mask with a fusible material;
d) positioning said connector under said mask in order to align each said contact tail with one of said preselected recesses of said mask;
e) melting said fusible material such that said fusible material within each said preselected recess flows onto said contact tail aligned with each said preselected recess to form a mass of fusible material on said contact tail;
f) solidifying said mass of fusible material on said contact tail such that a joint is formed between an outer surface of each said mass of fusible material and said contact tail of each said terminal; and
g) removing said mask from said connector.

2. The method as defined in claim 1, further including the step of:
d1) clamping said connector to said mask.

3. The method as defined in claim 2, further including the step of:
d1) flipping over said connector and mask.

4. The method as defined in claim 1, further including the step of:
d1) flipping over said connector and mask.

5. The method as defined in claim 1, wherein when said fusible material is filled into each said recess, a meniscus is defined, and said contact tail of each said terminal capable of abutting against one of said meniscuses of said fusible material during step (d).

6. The method as defined in claim 1, wherein when said fusible material is filled into each said recess, a meniscus is defined, said contact tail of each said terminal being proximate to, but not touching, one of said meniscuses of said fusible material during step (d).

7. The method as defined in claim 6, wherein said contact tail is generally L-shaped such that a short leg of said contact tail is defined, said short leg being parallel to said surface of said housing, said fusible material melted in step (e) flows onto said short leg of each said contact tail to form a mass of fusible material on said short leg of each said contact tail.

8. The method as defined in claim 7, wherein said mass of fusible material solidified in step (f) solidifies on said short leg of each said contact tail such that a butt joint is formed between said outer surface of each said mass of fusible material and said short leg of each said contact tail.

9. The method as defined in claim 1, wherein said contact tail is generally straight such that an end of said contact tail is defined, said end being parallel to said surface of said housing, said fusible material melted in step (e) flows onto said end of each said contact tail to form a mass of fusible material on said end of each said contact tail.

10. The method as defined in claim 9, wherein said mass of fusible material solidified in step (h) solidifies on said end of each said contact tail such that a butt joint is formed between said outer surface of each said mass of fusible material and said end of each said contact tail.

11. The method as defined in claim 1, wherein said mask has at least one passageway provided therethrough.

12. The method as defined in claim 11, wherein said at least one passageway extends between said first and second surfaces of said mask.

13. The method as defined in claim 11, wherein said at least one passageway extends between said second surface of said mask and one of said recesses formed in said first surface of said mask.

14. The method as defined in claim 13, wherein said fusible material is inserted into said preselected recesses through said at least one passageway.

15. The method as defined in claim 1, wherein each said recess defines a sidewall which is tapered.

16. The method as defined in claim 1, wherein said plurality of terminals are selectively plated with gold.

17. The method as defined in claim 1, wherein said plurality of terminals are selectively plated with nickel.

18. The method as defined in claim 1, wherein said mask is formed of thermoplastic LCP.

19. The method as defined in claim 1, wherein each of said mask and said connector have means for properly aligning said contact tails of each said terminal with one of said recesses of said housing.

20. The method as defined in claim 19, wherein said aligning means includes a raised portion on said mask for insertion into an aperture of said housing of said connector.

21. The method as defined in claim 1, wherein each of said mask and said connector have means for spacing said first surface of said mask from said surface of said housing of said connector.

22. The method as defined in claim 1, further including the step of:
(e1) providing a heat barrier/sink proximate to said housing of said connector.

23. The method as defined in claim 1, wherein in step (e), said melted fusible material in a portion of said preselected recesses flows onto said contact tail aligned with each said preselected recess to form a mass of fusible material on said contact tail, and said melted fusible material in another portion of said preselected recesses flows along said terminal to an end thereof opposite said contact tail to form a mass of fusible material on said opposite end of said terminal.

24. The method as defined in claim 1, wherein said fusible material is solder.

25. The method as defined in claim 1, wherein said fusible material includes flux for assisting in the joining of the fusible material to the terminal.

26. The method as defined in claim 1, wherein said terminal has flux applied thereto for assisting in the joining of the fusible material to the terminal.

27. The method as defined in claim 1, wherein said masses of fusible material which are selectively formed on said contact tails with varying volumes.

28. A combination used for forming an electrical connector, said combination comprising:
a mask having a first surface and a second surface, said mask having a plurality of recesses formed in said first surface thereof, each said recess capable of receiving a fusible material therein;
a connector having a housing and a plurality of terminals, said housing having a first surface, a second surface, and plurality of apertures extending through said housing from said first surface to said second surface, each said terminal being positioned and attached within one of said apertures of said housing, each said terminal having a contact tail positioned proximate to said second surface of said housing,
wherein at least one of said mask and said connector have means for aligning said mask relative to said connector upon said mask and said connector being brought together such that said contact tail of each said terminal is in alignment with one of said recesses of said mask, and wherein at least one of said mask and said connector have means for spacing said first surface of said mask from said second surface of said housing of said connector upon said mask and said connector being brought together.

29. A combination as defined in claim 28, wherein each said recess has an inwardly tapered sidewall.

30. A combination as defined in claim 28, wherein said mask has a plurality of passageways extending therethrough, each said passageway extending from said second surface of said mask to one of said recesses within said mask.

31. A combination as defined in claim 28, wherein said mask has a plurality of passageways extending therethrough, each said passageway extending from said second surface of said mask to said first surface of said mask and between said plurality of recesses.

32. A combination as defined in claim 28, further including a member, said member capable of being positioned against said first surface of said connector, said member capable of being connected to said mask such that said connector is positioned between said member and said mask.

33. A combination as defined in claim 28, wherein both said mask and said connector have alignment means for aligning said mask and said connector relative to each other, said alignment means in said mask being an enlarged aperture extending from said first surface thereof to said second surface thereof, said alignment means in said connector being an enlarged aperture extending from said first surface thereof to said second surface thereof, said enlarged apertures of said mask and said connector being equivalent in dimension.

34. A combination as defined in claim 28, wherein both said mask and said connector have spacing means for spacing said mask and said connector apart from each other, said spacing means in said mask being a plurality of indents provided in said first surface thereof, said spacing means in said connector being a plurality of protrusions projecting from said surface of said housing of said connector, each said protrusion capable of being positioned in one of said indents.
